(19) United States
(12) Patent Application Publication
(10) Pub. No.: US 2006/0182946 A1
(43) Pub. Date: Aug. 17, 2006

(54) Durable high performance fibre cement product and method on manufacture

(76) Inventors: Joseph Emmanual Zarb, New South Wales (AU); Leonard Silva, New South Wales (AU); Milton Terrence O'Chee, New South Wales (AU)

Correspondence Address: GARDERE / JAMES HARDIE;GARDERE WYNNE SEWELL, LLP, 1601 ELM STREET, SUITE 3000, DALLAS, TX, 75201, US

(21) Appl. No.: 10/551,873

(22) PCT Filed: Mar. 31, 2004
(86) PCT No.: PCT/IB04/00978

§ 371 Date: Sep. 30, 2005

(30) Foreign Application Priority Data
Mar. 31, 2003 (AU) 2003901529

(51) Int. Cl. C04B 14/38; C04B 24/00; B32B 3/26; B32B 27/38; B32B 27/40; B32B 27/30

(52) U.S. Cl. 428/312.4; 106/711; 106/724; 428/703; 428/413; 428/522; 428/423.1

(57) ABSTRACT

An engineered fibre reinforced cement product including a first major surface to which a carbonation reducing sealer is applied and a second generally opposing major surface to which a carbonation reducing sealer is applied, so as to reduce propensity for differential carbonation in the product. A method of manufacturing a durable fibre reinforced cement product, said method comprising steps of: (e) mixing a wet fibre reinforced cement formulation; (f) forming from said formulation a green product defining first and second generally opposing major surfaces; (g) curing the green product to form a cured product; and (h) applying a carbonation reducing sealer to said first and second major surfaces, so as to reduce propensity for differential carbonation in the product. An engineered fibre reinforced cement product including a first major surface with a reduced propensity to differential carbonation, wherein the product has a cement to silica ratio of between 0.29 and around 0.51 and a porosity of between 25% and around 45%.

### FIELD OF THE INVENTION

The present invention relates to improved high performance fibre cement products having a reduced propensity to carbonation or differential carbonation, and hence increased durability, and to methods of making those products.

The invention has been developed primarily for use in relation to external building cladding panels and will be described hereinafter with particular reference to this preferred field. However, it will be appreciated that the invention is equally applicable to other fibre reinforced cementitious products where improved weathering resistance and durability are important.

### BACKGROUND OF THE INVENTION

The following discussion of the prior art is intended to place the invention in an appropriate technical context and facilitate a proper understanding of its advantages. However, any discussion of the prior art throughout the specification should in no way be considered an admission that such prior art is widely known or forms part of common general knowledge in the field.

Fibre reinforced cement (FRC) products are increasingly being used in a variety of building applications and in an increasing range of climatically different situations and geographical regions. Such products have gained favour for their inherent fire, water, pest and mould resistance, as well as their general affordability, which makes them particularly suitable for use in meeting commercial as well as residential building codes. Moreover, FRC products are easily painted or otherwise coated or laminated with decorative finishes, such that they can be used in almost any architectural or interior design.

A growing use of FRC is in external and internal cladding panels which are manufactured by applying a customised finish to the front surface of an untreated FRC board. Such finishes may include various coatings, vinyl films, laminates or the like depending on the final appearance that is required.

Typically, the steps of applying paints or coatings to the surface of FRC products can be described as follows:—
One or more surfaces are sanded to improve surface smoothness and reduce thickness variation;
A sealer or “fillcoat” is applied to one or more surfaces.
The sealer or fillcoat is back sanded to further enhance smoothness. The steps of sealing and back sanding may be repeated several times until the surface achieves a predetermined degree of smoothness and thickness variation.
Optionally, a tie coat is applied on top of the sealer to enhance the adhesion of subsequent topcoats to the sealer.
One or more topcoats are applied to the tie coat and optionally backsanded and reapplied until the desired finish is obtained.

For high quality finishes, several iterations of sealing, backsanding and topcoating are usually required. What is needed is a way to combine one or more of these steps to reduce the overall cost of making finished FRC products.

Moreover, since exterior paints and topcoats are often formulated from different chemistries than sealers, a tie coat or keycoat must often be used to ensure the topcoat or paint continues to adhere to the sealer for as long as possible. Applying and curing tiecoats add to the cost of the finished FRC product. What is needed is a way to eliminate the need for a separate tie coat.

Although FRC products are known to be more durable than timber and other conventional building materials, exposure to the elements inevitably causes chemical changes in the FRC products over time. This is due in a significant part to the effect of atmospheric carbon dioxide on the cementitious product resulting from a process generally referred to as carbonation, wherein atmospheric CO2 diffuses into the FRC substrate and reacts with free calcium hydroxide or calcium silicate hydrates in the presence of water to form calcium carbonate, changing the crystalline structure of the FRC substrate. What is needed is a means of reducing the ingress of Carbon dioxide and water into the FRC substrate.

While manufacturers of FRC products typically recommend that the rear mounting surfaces of such panels be sealed appropriately, this is not always done by builders, and even when it is, the FRC manufacturer has no control over the quality of any hidden face sealing that may be applied. What is needed is a means of ensuring that FRC products are adequately sealed on the back prior to installation.

As a result of the above installation practices, some portions of an FRC product may carbonate at different rates depending on the degree of exposure and the integrity of sealers or other surface treatments. When different portions of the same FRC product carbonate at different rates, internal stresses develop. If these stresses are sufficiently significant they can manifest themselves visually in the form of surface cracking of the panels and/or warping and the like. What is needed is a means of ensuring carbonation or other types of degradation occur in a balanced, controlled manner, to reduce internal stresses within the FRC product.

The prior art discloses the use of various sealers on cementitious materials. For example, in EP-A 469 295, WO 96/33143 disclose the use of styrene-acrylate dispersions or pure acrylate dispersions to improve the protection of cementitious products from the efflorescence, a cosmetic problem in which atmospheric carbon dioxide reacts with calcium hydroxide that has leached onto the surface of the cementitious product.

EP-A 355 028 describes a process for preventing efflorescence phenomena on mineral substrates by applying, to a mineral substrate, a coating which comprises a conventional polymer as binder and an aromatic ketone as photosensitiser. This involves crosslinking of the surface of the coating.

U.S. Pat. No. 6,136,383 discloses coatings for mineral mouldings which effectively prevent efflorescence and at the same time do not disadvantageously change their strength and their visual appearance on exposure to moisture. The coating is made from a radiation-curable preparation based on polymers which have ethylenically unsaturated double bonds applied to the mineral moulding.

However, each of the preceding references focuses on reducing efflorescence, which is a surface phenomenon, as opposed to carbonation, which occurs internally within the FRC substrate. Controlling efflorescence requires a sealer which forms a water barrier. Controlling internal carbonation requires a sealer that forms a barrier to both carbon dioxide and water. In addition, the carbonation reducing sealer must be compatible with the alkaline chemistry of cementitous materials and be durable in the intended environment. An additional constraint is that the sealer must, on its own or in combination with other materials, ensure that decorative topcoats or other architectural coatings applied over the sealer maintain their adhesion to the sealer throughout the service life of the topcoat. What is therefore needed is a sealer that adequately meets the required performance criteria of:
Reducing or eliminating internal carbonation and specifically differential carbonation in an FRC composite;
Resisting alkaline attack and being otherwise compatible with cementitous materials; and
Maintaining topcoat adhesion throughout the service life of the topcoat, regardless of the type of topcoat used.

It has been suggested that polymeric films may be effective in this area For example, US20010004821A1 discloses the technique of laminating to a rear surface of FRC panel a preformed resin sheet of polyethylene, foamed polyethylene sheet, polyethylene terephthalate, vinyl chloride sheet or vinylidene chloride (or combinations thereof) prior to customisation or installation. This practice is unlikely to be commercially viable as the process would be costly, time consuming and an inefficient use of polymeric materials. Laminated films or sheets would not form an inter-penetrating network into the surface of the FRC product and therefore be susceptible to damage or abrasion from adjacent sheets during transport and storage. It would therefore limit the subsequent uses to which the resulting FRC product could usefully be employed. What is needed is a more efficient way to provide a carbonation reducing sealer to the back of an FRC product.

In the specific example of using prefinished FRC building panels for cladding commercial buildings, previous practice has been to use sealers as fillcoats to cover surface imperfections in FRC composites and to reduce excessive absorption or strike-in of expensive decorative topcoats into porous FRC substrates. These sealers were then back-sanded to provide a smooth surface for the topcoat or only a relatively thin film thickness. In either case, such sealers by themselves did not constitute effective carbonation reducing films and had to rely upon the presence of a thick topcoat layer to provide carbonation resistance. Topcoats have a limited service life, and at the end of that life the carbonation resistance of the FRC composite was compromised because the prior art method of appliying the sealer was not directed towards maintaining resistance to carbonation independently of the topcoat. What is needed is a method of providing ongoing carbonation resistance independently of the topcoats on FRC composites.

U.S. Pat. No. 6,162,511 discloses radiation curable coating formulations suitable for FRC products but does not disclose a means of determining which of these coatings would be suitable for reducing carbonation in FRC. Neither does it disclose methods of using the coating formulations described therein to provide sealers that will protect FRC composites from carbonation independently of the topcoats.

It is an object of the present invention to provide a high performance fibre reinforced cement product and methods of making that product which overcome or ameliorate one or more of the foregoing disadvantages of the prior art, or at least provide a useful alternative.

### DISCLOSURE OF THE INVENTION

According to a first aspect of the invention, there is provided an engineered fibre reinforced cement product including a first major surface to which a carbonation reducing sealer is applied and a second generally opposing major surface to which a carbonation reducing sealer is applied, so as to reduce propensity for differential carbonation in the product.

In the description herein, a sealer will refer to a coating or film of polymeric, organic or inorganic composition, that is directly in contact with the FRC substrate and has the effect of reducing or eliminating the transport of carbon dioxide and liquid water from the external environment into the FRC substrate. To be a functionally effective sealer, the coating must be substantially free of holes, pores, cracks or other defects that allow relatively rapid ingress of water or carbon dioxide.

As used herein, a topcoat or a paint refers to a coating or film of polymeric, organic or inorganic composition that provides for decoration and is applied after or on top of a sealer. Topcoats or paints are usually directly exposed to the external environment and eventually degrade with time and exposure.

Preferably, a carbonation reducing sealer is applied to substantially all surfaces of the product. The carbonation reducing sealer applied to at least one of said first and second major surfaces is preferably a radiation curable sealer. The sealer is preferably curable by a form of radiation selected from the group comprising: UV, infrared or near infrared; RF, microwave; gamma, and electron beam radiation. In alternative embodiments, however, the sealer may be thermally, air or chemically curable.

The sealer applied to at least one of the first and second major surfaces is preferably composed substantially of a formulation selected from the group comprising: acrylics; epoxy acrylates, and urethane acrylate sealers. The sealer may optionally include an integral adhesion promoting formulation. It should be appreciated that the sealers applied to the first and second major surfaces may be composed of substantially the same formulation, or of different formulations.

The radiation curable sealer preferably comprises a prepolymer or binder polymer or mixtures thereof The prepolymer may, for example, comprise one or more oligomer selected from ethylenically unsaturated polyesters, ethylenically unsaturated polyethers, ethylenically unsaturated polyurethanes, ethylenically unsaturated epoxy, oligo-ester(meth)acrylates and ethylenically unsaturated poly(meth)acrylates and modified products thereof Typical prepolymers which may be used are acrylated oligomers selected from polyurethane, epoxy, polyesters, polyethers and copolymers and block copolymers thereof.

In one preferred embodiment, the sealer applied to at least one of said first and second major surfaces is provided with adhesion enhancing means adapted to enhance bonding of a subsequently applied topcoat. Alternatively, the sealer maybe covered by a separate keycoat adapted to enhance bonding of a topcoat. In some applications, however, it should be appreciated that a keycoat is not required.

The sealer applied to each of the major surfaces is preferably at least 15 microns, more preferably between 15 microns and around 80 microns, and most preferably between 15 microns and around 50 microns in overall thickness. The sealer may be applied in a single application, or alternatively in multiple coats or stages. The sealer may also be cured in multiple stages.

In one preferred embodiment, a keycoat is applied over the sealer on at least one of the major surfaces following partial curing and prior to full curing of the sealer, to enhance bonding between the sealer and the keycoat. Similarly, a topcoat may be applied over the sealer on at least one of the major surfaces following partial curing and prior to full curing, to enhance bonding between the sealer and the topcoat.

Preferably, the sealer is substantially alkali resistant, is preferably sufficiently cross-linked to impede migration of carbon dioxide through the sealer to a predetermined extent, and is preferably substantially flexible in the cured state.

Preferably, one or more of the chemical composition of the formulation, the method of manufacture, and the physical structure of the cured product, are selected in conjunction with the sealer to reduce propensity for differential carbonation in the product.

The formulation has a cement to silica ratio that is preferably between 0.2 and around 1.5, more preferably between 0.3 and around 0.9, more preferably between 0.3 and around 0.5, more preferably still between 0.36 and around 0.43, and most preferably around 0.39 on a dry weight basis.

The product is preferably formed to achieve a predetermined porosity and density during manufacture. The porosity and density are specifically selected to provide improved resistance to carbonation or differential carbonation. The predetermined porosity and density may be attained by, for example, by pressing the uncured FRC product in an uncured state until the target density and porosity are achieved. Alternatively, the predetermined porosity and density may be achieved by applying particle packing theory when selecting the proportions of the materials used to make the FRC product. Methods of pressing either by stack press, embossing rolls or filter press are well known in the industry.

The product has a porosity that is preferably between 30% and around 60%, and more preferably between 35% and around 45%. The product has a relative density that is preferably between 0.5 and around 2.0, more preferably between 0.8 and around 1.9, and more preferably still between 1.2 and 1.6.

The FRC product is preferably formed using a Hatschek process, but may alternatively be formed by extrusion, the Mazza technique, manual lay-up, or by other suitable means.

In the preferred embodiment, the product is a fibre reinforced cement sheet product configured for use as an exterior cladding panel. Preferably, the sheet is substantially rectangular in shape, and the carbonation reducing sealer is applied to all six sides.

Desirably, the first major surface of the sheet product is a mounting surface adapted for inward orientation toward a substrate and the second major surface of the sheet product is an exposed surface adapted for outward orientation. The substrate is preferably takes the form of a building frame.

According to a second aspect, the invention provides a method of manufacturing a durable fibre reinforced cement product, said method comprising steps of:

mixing a wet fibre reinforced cement formulation;

forming from said formulation a green product defining first and second generally opposing major surfaces;

curing the green product to form a cured product; and

applying a carbonation reducing sealer to said first and second major surfaces, so as to reduce propensity for differential carbonation in the product.

One preferred example of a conventional process for forming a green fibre cement product is described in Australian Patent Number 515151, which is incorporated herein in its entirety by reference.

Preferably, the carbonation reducing sealer is applied to substantially all surfaces of the product. The carbonation reducing sealer is preferably a radiation curable sealer. More preferably, the sealer is curable by a form of radiation selected from the group comprising: UV, infrared or near infrared; RF, microwave; gamma and electron beam radiation. Alternatively, however, the sealer may be thermally, air or chemically curable.

The FRC curing step is preferably performed using a process selected from the group comprising: autoclave, air and steam curing.

Preferably, the method includes the further step of compressing the green product prior to curing in a controlled manner such that the cured product exhibits a reduced carbonation gradient through its cross-sectional profile. The compression step includes application of pressure to the green product to achieve a porosity that is preferably between 30% and around 60%, and more preferably between 35% and around 45%.

The method in one embodiment preferably includes the further step of applying a keycoat over the sealer following partial curing and prior to full curing, to enhance bonding between the sealer and the keycoat. In an alternative embodiment, the method preferably includes the further step of applying a topcoat over the sealer following partial curing and prior to full curing, to enhance bonding between the sealer and the topcoat.

Desirably, the preferred radiation curable sealer comprises a radiation curable acrylic copolymer sealer. More preferably, the acrylic copolymer sealer is a clear epoxy acrylate sealer. More preferably, the radiation curable sealer combines the functions of a carbonation reducing sealer and a key coat so as to improve the adhesion of subsequent topcoats.

Further, it should be appreciated that the sealer can be applied during the FRC manufacturing process, or alternatively, can be applied shortly before, or even after the product is mounted to the substrate. Moreover, the first and second major surfaces can be sealed simultaneously or at different times. For example, the first major surface can be sealed during the FRC manufacturing process and the second major surface can be sealed in-situ.

According to a third aspect, the invention provides an engineered fibre reinforced cement product including a first major surface with a reduced propensity to differential carbonation, wherein the product has a cement to silica ratio of between 0.29 and around 0.51 and a porosity of between 25% and around 45%.

Preferably, the product includes a major surface to which a carbonation reducing sealer is applied. More preferably, a carbonation reducing sealer is applied to substantially all surfaces of the product. In a preferred embodiment, the carbonation reducing sealer applied to at least one of the major surfaces of the product is a radiation curable sealer.

### BRIEF DESCRIPTION OF THE DRAWINGS

A preferred form of the invention will now be described, by way of example only, with reference to the incorporated tables and accompanying drawing in which:

FIG. 1 is a flow chart showing a typical method of making a high performance compressed product in accordance with various aspects of the invention.

### PREFERRED EMBODIMENTS OF THE INVENTION

The present invention has been developed primarily for use in the manufacture of high performance compressed fibre cement sheets specifically configured for use as external or internal building cladding and lining panels and will be described hereinafter with reference to this application.

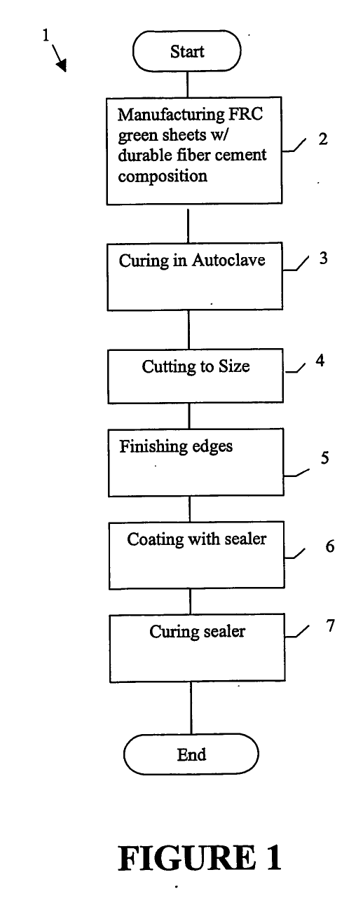

Referring to FIG. 1, there is shown a flow chart 1 of a typical manufacturing process that is suitable for use with preferred forms of the invention configured for producing building cladding panels. Referring to this flow chart, it can be seen that the first step 2 is the manufacture of an FRC green sheet, which in preferred forms is made from a fibre cement composition that falls generally within the ranges set out in the table below.

| | Acceptable range | Preferred range | Optimal formula |
|---|---|---|---|
| Dry Ingredients | (% by dry weight) | (% by dry weight) | (% by dry weight) |
| Cement | 20-3.0% | 23.5-26.5% | 25.0% |
| Silica | 58.5-68.5% | 62-65% | 63.5% |
| Pulp | 5.5-10.5% | 7-9% | 8.0% |
| Additives | 2-5% | 2.5-4.5% | 3.5% |

| Proportions | Acceptable range | Preferred range | Optimal ratio |
|---|---|---|---|
| Cement:Silica | .292-.513 | .362-.427 | .394 |

This preferred composition has a reduced cement to silica ratio when compared with at least some other prior art formulations, the reduced cement component contributing to an overall reduction in carbon dioxide reactions within the finished product. The cement is typically ordinary Portland cement type 1, and the silica can be any suitable silica such as 200G milled quartz. Examples of suitable siliceous materials include, but are not limited to, amorphous silica, diatomaceous earth, rice hull ash, blast furnace slag, granulated slag, steel slag, mineral oxides, mineral hydroxides, clays, magnasite or dolomite, polymeric beads, metal oxides and hydroxides, or mixtures thereof.

Preferred pulps include various forms of cellulose fibres, such as hammer-milled Kraft pulp. However, it will be appreciated that other forms of fibres may be used. In a particularly preferred embodiment, the fibre is cellulose wood pulp. Other examples of suitable fibres are ceramic fibre, glass fibre, mineral wool, steel fibre, and synthetic polymer fibres such as polyamides, polyester, polypropylene, polymethylpentene, polyacrylonitrile, polyacrylamide, viscose, nylon, PVC, PVA, rayon, glass ceramic, carbon, or any mixtures thereof.

It should also be noted that optional additional additives can be incorporated in to the composition including viscosity enhancing agents, density modifiers, dispersing agents, fly ash, silica fume, geothermal silica, fire retardant, thickeners, pigments, colorants, plasticisers, dispersants, foaming agents, flocculating agents, water- proofing agents, organic density modifiers, aluminum powder, kaolin, alumina trihydrate, mica, metakaolin, calcium carbonate, wollastonite, polymeric resin emulsions, or mixtures thereof, as required.

In the preferred methods, the sheets are produced using the Hatschek process in the conventional manner well known to those skilled in the art. The Hatschek process uses a rotating drum sieve arrangement to deposit a plurality of layers of de-watered slurry onto an absorbent conveyer until the desired sheet thickness has been achieved.

The preferred green sheet manufacturing process referenced in the flow chart 1 is set to produce a plurality of green sheets of a particular size which are then stacked one upon another and then optionally conveyed to a pressing station. At the pressing station, the press is programmed to take into account the sheet size and the stack height and the products are pressed to achieve a porosity of between 30% and around 60%, and more preferably between 35% and around 45%. This pressure is maintained for a predetermined time period as determined by trial experiment to achieve the desired outcomes in the final product. After pressing, the compressed green products are cured. The curing can be carried out in an autoclave in the conventional manner as set out in step 3, or using any number of other conventional techniques including air curing.

When curing has been completed, the sheets are typically cut to size (step 4) and the edges are finished (step 5) by passing through a conventional sheet finishing line where they are optionally trimmed to size with an edge router to exact dimensions. The finished FRC sheets are placed in a stack as they come off the sheet finishing line.

Optionally, a carbonation reducing sealer, which is preferably a radiation curable epoxy acrylate sealer, can be applied to the edges of each FRC sheet before it leaves the sheet finishing line (step 6). The coating is preferably curable by UV radiation. However, coatings based on alternative curing mechanisms such as electron beam, RF, microwave, infrared and chemical curing may also be used. Preferred sealer formulations include epoxies, urethanes, polyesters, acrylates, and combinations of such formulations.

In some preferred forms of the invention, the finished FRC sheet is then fully coated on all six sides (the front face and mounting face being the two major faces, and the four edges) with a sealer of the same kind as shown in step 6. This may be done by first manually roll coating or spraying the sealer on the edges of the stack of FRC sheets and then individually roll coating the sealer on the face and back of an FRC sheet using a conventional roll coater. Typically, a stack of 16 sheets is edge coated at one time to maximise efficiency, but to prevent drying before the FRC sheets go through the roll coater and are cured. Preferably, the coating thickness is in the range of 15 to 50 microns.

Finally, where the applied carbonation reducing sealer is a radiation curable sealer, the sealer is then cured with a suitable radiation source appropriate to the sealer formulation (step 7). Typical radiation curing systems which may be configured to cure the coatings used in the invention may be obtained from Fusion Systems Inc. (910 Clopper Rd. Gaithersburg, Md.), which provides actinic (UV) curing equipment, Advanced Electron Beam (10 Upton Drive, Wilmington, Mass.) and Energy Sciences, Inc (42 Industrial Way, Wilmington, Mass. 01887 USA) for electron beam curing equipment. Other means of curing radiation curable coatings are known, including gamma radiation, near infrared radiation, and microwave radiation. Curing may be carried out in atomospheric conditions or under an inert atomosphere, such as a nitrogen blanket or CO2. It may also be suitable for combine radiation curing with traditional thermal curing as is disclosed in U.S. patent application US20030207956A1 and incorporated herein in its entirety as a reference.

If the sealer is a UV curable sealer, the sealer may be cured using UV lamps that provide UV radiation of wavelength from 250 to 400 nm at an intensity of between 200 and 600 watts per inch, and more preferably between 300 and 600 watts per inch.

If the sealer is cured by electron beam, the electron source will provide an intensity of between 50 to 600 KeV,and more preferably between 150 to 300 KeV. Regardless of the radiation source, most radiation curable sealers will be adequately cured after exposure to 80 to 3,000 mJ/cm2 of radiation. Optionally, residual cosolvent or water remaining in the coating may be removed by heating the substrate up to a temperature of 80 C via exposure to IR or NIR radiation. The carbonation reducing sealers used in the invention may also be thermally cured using conventional thermal curing techniques.

The carbonation reducing sealers suitable for this invention are specifically selected to reduce transport of both carbon dioxide gas and water. These sealers may be formulated as solvent based, water based, powder coating or the like. They may be considered to be 100% solids or reduced with a suitable solvent or water to achieve a viscosity suitable for the chosen application method. Where the carbonation reducing sealer is a radiation curable sealer, the sealer may be applied and cured using the techniques described in U.S. Pat. No. 3,935,364, WO0220677A1 and U.S. Pat. No. 6,136,383, each of which is incorporated herein in their entirety as references. Roll coating, curtain coating, spray coating, powder coating and the like are all suitable techniques for applying the sealer. In addition, the sealer may be applied at an elevated temperature, for example between 30° C. and 150° C., in order to enhance curing and adhesion of the sealer. Alternatively, the substrate itself may be heated to between 30° C. and 150° C. achieve the same effect.

Sealer compositions may also comprise, besides the polymeric binder, fillers and/or pigments, and also usual auxiliaries such as wetting agents, viscosity modifiers, dispersants, defoamers, preservatives and hydrophobisizers, biocides, fibers and other typical constituents. Examples of suitable fillers are aluminosilicates, silicates, alkaline-earth metal carbonates, preferably calcium carbonate in the form of calcite or lime, dolornite, and also aluminum silicates or magnesium silicates, such as talc. Typical pigments are titanium dioxide, iron oxides and barium sulfate. In the case where radiation curable sealers are used, catalysts or accelerants such as those disclosed in WO0220677A1 may be used to accelerate the curing of the sealer.

Carbonation reducing sealers which are aqueous dispersions have a solids content generally in the range from 20 to around 80% by weight, and more preferably from 30 to around 60% by weight, based on the total weight of the conventional coating. Of this, preferably at least 30% by weight, more preferably at least 50% by weight, and most preferably from 50 to around 90% by weight, is made up by the polymeric binder. Preferably, not more than 70% by weight, and more preferably from 10 to around 50% by weight, is made up by pigments and/or fillers. In the case of a clear sealer, the pigment and/or filler content will typically be less than around 10%. In the case of a keycoat or a combination keycoat/sealer, the filler content will be between 10% and around 70%, and more preferably between 10% and around 50%.

Carbonation reducing sealers are formulated using a prepolymer or binder polymer or mixtures thereof. The prepolymer may, for example, comprise one or more oligomers selected from ethylenically unsaturated polyesters, ethylenically unsaturated polyethers, ethylenically unsaturated polyurethanes, ethylenically unsaturated epoxy, oligo-ester(meth)acrylates and ethylenically unsaturated poly(meth)acrylates and modified products thereof Typical of prepolymers that may be used are acrylated oligomers selected from polyurethane, epoxy, polyesters, polyethers and copolymers and block copolymers thereof.

Examples of preferred polymer binders used in a radiation curable sealer that are effective at reducing carbonation are epoxy acrylates and urethane acrylates. These may be obtained from resin formulators and suppliers such as BASF, PPG Industries, Sartomer, Ballina Pty Ltd or Akzo Nobel.

Specific sealers that have shown utility as carbonation reducing sealers are R60301-001 UV curable acrylic clear sealer manufactured by Akzo Nobel, VC7 clear and VC9 white UV curable epoxy acrylate sealers manufactured by Architectural and Industrial Coatings Pty. Ltd. of Moss Vale Australia. When combined with, for example, R80179-001 key cote (Akzo Nobel), having a wet adhesion promoter and a relatively high pigment loading, the sealer may be coated with a durable polyurethane or epoxy based decorative topcoat.

Durable adhesion of the topcoat may be achieved by the use of a keycoat applied to the surface of the sealer, the keycoat having a predetermined binder/filler ratio and optionally having one ore more adhesion promoters. Typical adhesion promoters are: silianes, silanols, siliconates or other silicon based adhesion promoters or coupling agents known in the art. Amine- or Amino-based adhesion promoters may also be used. These keycoats are used predominantly to provide improved adherance to water based coatings such as water based acrylics, as distinct from polyurethane and epoxy based topcoats, but any suitable keycoat formulations may be used in appropriate circumstances to enhance bonding.

The fillers used for the key coat are selected to achieve a predetermined degree of surface roughness in the cured keycoat to enable mechanical bonding. Talc, mica, carbonates and other minerals are suitable for this application.

Additionally, a sealer may have an adhesion promoter incorporated directly into its formulation, in order to eliminate the need for a key coat. Amine based or silane based adhesion promoters have been shown to be effective. The sealer may also have a surface that is made rough through the use of specific fillers or by the method of curing.

It will be appreciated that the invention as described illustrates numerous ways in which an FRC product of reduced propensity to carbonation or differential carbonation and hence improved durability can be produced. For example, the reduced cement to silica ratio generally reduces carbon dioxide reactions within the product, thereby minimising any differential carbonation that may apply across various sheet boundaries and through the final sheet itself

Similarly, it is believed that controlling permeability and rigidity (as may be affected by density), allows carbonation gradients across a sheet to be controlled, particularly where the various surfaces may have different levels and types of sealing.

Finally, the factory application of a sealer, and more particularly a carbonation reducing sealer such as an acrylic UV curable sealer, to at least the mounting surface of the panels in a controlled fashion, ensures that there is no risk of the panels being mounted without adequate sealing on the mounting surface, thereby again reducing the potential carbonation differential of the finished panel once it has been installed. There is the added advantage with original manufacturer pre-sealing of increasing the longevity of the base board during transport and storage. It also makes it significantly easier for cladding panel finishers and installers to apply additional coatings and the like. Certainly, sealing on all six surfaces of a panel greatly reduces the chance of severe differential carbonation across a panel, particularly as can occur when one or more sides are left untreated.

Each of the above discussed process steps and features separately define inventive methods of making improved compressed FRC products. Furthermore, when these process steps and features are combined, which can be done in numerous different ways, there is a synergistic interaction that enables production of products having vastly superior performance characteristics over the prior art.

### EXAMPLE

The following example shows the application of the invention, in one of its preferred embodiments, to a compressed PRC sheet manufactured by the applicant and sold under the “ExoTec” product name. The general specifications of this product are set out below, with C:S denoting the ratio of cement to silica in the formulation.

Porosity v Density v C:S Ratios & Pressing Pressures for Test Products

| | Porosity | Density | C:S | C:S | C:S |
|---|---|---|---|---|---|
| Product | (vol %) | gm/cc | Possible | Preferred | Optimum |
| Compressed - | 30-40% | 1.2-1.6 | 0.29-0.51 | 0.34-0.46 | 0.39 |
| Lite (ExoTec) | | (1.55 | | | |
| | | Avg) | | | |

Formulation Ranges for Porosity and Chemistry Modified Compressed FC

| | Acceptable range | Preferred range | Optimal formula |
|---|---|---|---|
| Dry Ingredients | (% by dry weight) | (% by dry weight) | (% by dry weight) |
| Cement | 20-30% | 23.5-26.5% | 25.0% |
| Silica | 58.5-68.5% | 62-65% | 63.5% |
| Pulp | 5.5-10.5% | 7-9% | 8.0% |
| Additives | 2-5% | 2.5-4.5% | 3.5% |

| | Acceptable range | Preferred range | Optimal ratio |
|---|---|---|---|
| Cement:Silica | .292-.513 | .362-.427 | .394 |

The product is pressed in the green state using a stack press to form a product with a porosity between 30 and 40% and a target density of about 1.55 g/cc. The product was then precured for around 80 hours at around 60° C., followed by autoclave curing at between 120° C. and 200° C., for around 24 hours. The product was then sealed in the manner previously described, and tested.

Test Results

Accelerated testing of a conventional high density coated FC composite article and a composite FRC article formulated and coated as outlined in this example shows the significant performance benefits of the present invention. Under accelerated heat/rain/carbonation cycling, conventional products show a tendency to deform due to the effects of differential carbonation. These effects are generally dampened but not eliminated by most traditional surface coating treatments that may be applied.

The FRC composite of this invention shows a surprising and unexpected improvement in performance. The table below shows deflection results after an accelerated test involving fixing a sample of the composite FC product at predetermined points to a support frame, preconditioning the composite system in a carbon dioxide rich atmosphere for 8 hours followed by a predetermined number of cycles of heating to 70C on one surface for 1 hour then surface wetting at ambient temperatures for 1 hour.

Samples are instrumented to record permanent deflection away from their initial fixing position. Deflections are seen as bowing or warping of a product away from a support frame to which the sample is fixed. Nil or minimum deflection indicates a sample that has performed satisfactorily. Deflections of 50% or more of the composite product's thickness generally indicate that the article may not be stable in severe environment applications.

Deflection Vs Time in Accelerated Weathering Test

| | Conventional High Density | Present Invention |
|---|---|---|
| Time | 9 mm thick Coated FRC | 9 mm thick. |
| (mins) | deflection (mm) | Deflection (mm) |
| 0 | 0 | 0 |
| 20 | .5 | 0.4 |
| 40 | 1.0 | 0.8 |
| 60 | 1.8 | 1.2 |
| 100 | 3.5 | 2 |
| 200 | 3.8 | 2 |
| 400 | 6.5 | 1.75 |
| 600 | 9 | 1.6 |
| 800 | 9 | 1.55 |
| 1000 | 11 | 1.5 |
| 1200 | 11 | 1.45 |
| 1400 | 10.5 | 1.4 |

The tables below shows the % carbonation of the hydrated cement phases present in the front face, the centre and the rear or mounting face of a fibre cement composite construction panel made according to the example, compared to an unsealed standard FRC formulation.

Exotec FRC Panel Sealed On Front Face

| Location | Front | Centre | Rear | Deflection(mm) |
|---|---|---|---|---|
| Sealed (Rear) | 12.1 | 14.7 | 16.8 | 1.0 |
| Not sealed (Rear) | 51.2 | 63.3 | 61.5 | 2.0 |

Conventional FRC Panel Sealed on Front Face

| Location | front | centre | rear | Deflection(mm) |
|---|---|---|---|---|
| Sealed (Rear) | 12.3 | 17.9 | 19.3 | 2.14 |
| Not sealed (Rear) | 16.8 | 22.4 | 37.7 | 11.0 |

Observations

Clearly, the test sample manufactured and sealed in accordance with the present invention demonstrates superior performance in terms of deformation and carbonation under the test conditions, than the corresponding sample according to the prior art.

Thus, it will be appreciated that significant research and development by the applicant has resulted in the unexpected realisation of an important mechanism of degradation and deformation in fibre reinforced cement products that was not previously understood, in terms of differential carbonation. Flowing from this realisation, through the synergistic interaction of specifically formulated sealers and coatings, preferably when used in conjunction with modified permeability profiles achieved through specifically engineered density porosity characteristics, manufacturing techniques and chemical compositions to collectively induce moderate and reilatively even carbonation gradients in the product, a major limitation of the prior art is able to be effectively addressed to a significant degree. Accordingly, the invention represents a practical and commercially significant improvement over the prior art.

Finally, it will be appreciated by those skilled in the art that while the inventive aspects are particularly suited to FRC compressed sheeting and panels, they are equally applicable to other FRC products. Similarly, while the preferred examples illustrate particular compositions, pressure ranges and sealants, the invention may be embodied in many other forms to achieve the same advantageous results.

1. An engineered fibre reinforced cement product including a first major surface to which a carbonation reducing sealer is applied and a second generally opposing major surface to which a carbonation reducing sealer is applied, so as to reduce propensity for differential carbonation in the product.

2. A product according to claim 1, wherein a carbonation reducing sealer is applied to substantially all surfaces of the product.

3. A product according to claim 1, wherein the carbonation reducing sealer applied to at least one of said first and second major surfaces is a radiation curable sealer.

4. (canceled)

5. A product according to claim 1, wherein the sealer applied to at least one of said first and second major surfaces is thermally, air or chemically curable.

6. A product according to claim 1, wherein the sealer applied to at least one of said first and second major surfaces is composed substantially of a formulation selected from the group comprising: acrylics; epoxy acrylates, and urethane acrylate sealers.

7. A product according to claim 1, wherein the sealer applied to at least one of said first and second major surfaces includes an integral adhesion promoting formulation.

8. (canceled)

9. (canceled)

10. A product according to claim 1, wherein the sealer applied to at least one of said first and second major surfaces includes an adhesive formulation adapted to enhance bonding of a topcoat.

11. A product according to claim 1, wherein the sealer applied to at least one of said first and second major surfaces is covered by a separate keycoat adapted to enhance bonding of a topcoat.

12. (canceled)

13. A product according to claim 1, wherein the sealer applied to each of the major surfaces is between 15 microns and around 80 microns in overall thickness.

14. (canceled)

15. (canceled)

16. (canceled)

17. (canceled)

18. (canceled)

19. A product according to claim 1, wherein the carbonation reducing sealer is substantially alkali resistant.

20. A product according to claim 1, wherein the carbonation reducing sealer is sufficiently cross-linked to impede migration of carbon dioxide through the sealer to a predetermined extend.

21. (canceled)

22. (canceled)

23. A product according to claim 1, wherein the sealer has a cement to silica ratio of between 0.2 and around 1.5 on a dry weight basis.

24. (canceled)

25. (canceled)

26. (canceled)

27. (canceled)

28. (canceled)

29. A product according to claim 1, having a porosity of between 30% and around 60%.

30. (canceled)

31. A product according to claim 1, having a relative density of between 0.5 and around 2.0

32. (canceled)

33. (canceled)

34. (canceled)

35. A product according to claim 1, being a fibre reinforced cement sheet product configured by use as an exterior cladding panel.

36. (canceled)

37. A product according to claim 35, wherein the first major surface of the sheet product is a mounting surface adapted for inward orientation toward a substrate and the second major surface of the sheet product is an exposed surface adapted for outward orientation.

38. A method of manufacturing a durable fibre reinforced cement product, said method comprising steps of:
(a) mixing a web fibre reinforced cement formulation;
(b) forming from said formulation a green product defining first and second generally opposing major surfaces;
(c) curing the green product to form a cured product; and
(d) applying a carbonation reducing sealer to said first and second major surfaces, so as to reduce propensity for differential carbonation in the product.

39. (canceled)

40. A method according to claim 38, wherein the carbonation reducing sealer applied to at least one of said first and second major surfaces is a radiation curable sealer.

41. (canceled)

42. (canceled)

43. A method according to claim 38, wherein the sealer applied to at least one of said first and second major surfaces is selected from the group comprising: acrylics; epoxy, acrylates, and urethane acrylate sealers.

44. A method according to claim 38, wherein the sealer applied to at least one of said first and second major surfaces includes an integral adhesion promoting composition.

45. (canceled)

46. (canceled)

47. A method according to claim 38, wherein the curing step is performed using a process selected from the group comprising: autoclave, air and steam curing.

48. A method according to claim 38, wherein the product is a sheet product configured for use as an exterior cladding panel.

49. (canceled)

50. A method according to claim 50, wherein the first major surface of the sheet product is a mounting surface adapted for inward orientation toward a substrate and the second major surface of the sheet product is an exposed surface adapted for outward orientation.

51. A method according to claim 50, wherein the substrate is a supporting frame.

52. A method according to claim 38, wherein one or more of the chemical composition of the formulation, method of manufacture, and physical structure of the cured product, are selected to reduce propensity for carbonation in the product.

53. A method according to claim 52, including the further step of compressing said green product prior to curing in a controlled manner such that the cured product exhibits a reduced carbonation gradient.

54. A method according to claim 50, wherein the cured product has a porosity of between 30% and around 60%.

55. (canceled)

56. A method according to claim 50, wherein the cured product has a relative density of between 0.5 and around 2.0.

57. (canceled)

58. A method according to claim 50, wherein said wet fibre reinforced cement formulation has a cement to silica ratio of between 0.2 and around 1.5 on a dry weight basis.

59. (canceled)

60. (canceled)

61. (canceled)

62. (canceled)

63. (canceled)

64. (canceled)

65. A method according to claim 38, wherein the carbonation reducing sealer is applied in multiple coats or stages.

66. (canceled)

67. (canceled)

68. (canceled)

69. A method according to claim 38, wherein the carbonation reducing sealer applied to at least one of the major surfaces is cured in multiple stages.

70. A method according to claim 69, including the further step of applying a keycoat over the sealer following partial curing and prior to full curing, to enhance bonding between the sealer and the keycoat.

71. A method according to claim 69 or claim 70, including the further step of applying a topcoat over the sealer following partial curing and prior to full curing, to enhance bonding between the sealer and the topcoat.

72. An engineered fibre reinforced cement product including a first major surface with a reduced propensity to differential carbonation, wherein the product has a cement to silica ratio of between 0.29 and around 0.51 and a porosity of between 25% and around 45%.

73. A product according to claim 72, including a major surface to which a carbonation reducing sealer is applied.

74. A product according to claim 73, wherein a carbonation reducing sealer is applied to substantially all surfaces of the product.

75. A product according to claim 73 or claim 74, wherein the carbonation reducing sealer is a radiation curable sealer.
